(19) United States
(12) Patent Application Publication
(10) Pub. No.: US 2009/0279796 A1
(43) Pub. Date: Nov. 12, 2009

(54) METHOD AND APPARATUS FOR ENCODING AND DECODING IMAGE

(75) Inventors: Dai-woong Choi, Seoul (KR); Woo-sung Shim, Suwon-si (KR); Sung-bum Park, Seongnam-si (KR); Young-ho Moon, Suwon-si (KR); Jong-bum Choi, Yangju-si (KR); Jae-won Yoon, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/247,545

(22) Filed: Oct. 8, 2008

(30) Foreign Application Priority Data
May 9, 2008 (KR) 10-2008-0043470

(51) Int. Cl. G06K 9/46; G06K 9/36

(52) U.S. Cl. 382/233; 382/238

(57) ABSTRACT

Provided are a method and apparatus for encoding and decoding an image. The method of encoding an image includes generating half-tone data by applying patterns specified by each color channel to input data, rearranging the generated half-tone data according to the characteristics of the applied patterns, and predicting the rearranged half-tone data and encoding the predicted half-tone data. Therefore, encoding and decoding can be performed more efficiently and a compression rate can be improved.

### CROSS-REFERENCE TO RELATED PATENT APPLICATION

This application claims priority from Korean Patent Application No. 10-2008-0043470, filed on May 9, 2008, in the Korean Intellectual Property Office, the disclosure of which is incorporated herein in its entirety by reference.

### BACKGROUND OF THE INVENTION

1. Field of the Invention

Apparatuses and method consistent with the present invention relate to encoding and decoding an image, and more particularly, to encoding and decoding an image using the characteristics of patterns of a halftone image.

2. Description of the Related Art

In general, image forming devices such as a printer, fax, and copying machine substantially deliver various color senses with only two colors corresponding to black and white. For example, a color digital printer indicates a color image appearing on a monitor by two values corresponding to black and white. In this case, in order to print out the color images having a various brightness appearing on the monitor using the color digital printer, the printer or a personal computer (PC) performs a series of processes to convert the input image into a binary image. In other words, the printer or PC converts the images with pixels into images with grey scale ranging from 0 to 255 and then, the images with grey scale are converted into binary images. An image having grey scale values between 0 and 255 is denoted as a grey-scale image and the process of converting the grey-scale image into the binary image is denoted as half-toning.

In general, a host device encodes the half-toned binary image data using Joint Bi-level Image experts Group (JBIG) or JBIG 2 compression technology and transfers the encoded image to the image forming device. In addition, the image forming device decodes and outputs data received from the host device.

However, in conventional encoding and decoding of an image, even though the images include specific image patterns in each line according to the masks during half-toning, the images are encoded or decoded regardless of the image patterns so that encoding and decoding is inefficiently performed, thereby decreasing a compression ratio.

### SUMMARY OF THE INVENTION

The present invention provides a method and apparatus for encoding and decoding an image by arranging the image according to the characteristics of patterns applied to generate half-tone data.

According to an aspect of the present invention, there is provided a method of encoding an image, the method including: generating half-tone data by applying patterns specified by each color channel to input data; rearranging the generated half-tone data according to the characteristics of the applied patterns; and predicting the rearranged half-tone data and encoding the predicted half-tone data.

According to another aspect of the present invention, there is provided an apparatus for encoding an image, the apparatus including: a half-tone data generator generating half-tone data by applying patterns specified by each color channel to input data; a preprocessor rearranging the generated half-tone data according to the characteristics of the applied patterns; an entropy encoding unit predicting the rearranged half-tone data and encoding the predicted half-tone data.

According to another aspect of the present invention, there is provided a method of decoding an image, the method including: decoding half-tone data that is rearranged and encoded according to the characteristics of patterns applied in generating the half-tone data and predicting the decoded half-tone data; and arranging the predicted half-tone data in a reverse order with respect to the order of rearranging the generated half-tone data.

According to another aspect of the present invention, there is provided an apparatus for decoding an image, the apparatus including: a decoding unit decoding half-tone data that is rearranged and encoded according to the characteristics of patterns applied in generating the half-tone data, and predicting the decoded half-tone data; and a postprocessor arranging the predicted half-tone data in a reverse order with respect to the order of rearranging the generated half-tone data.

According to another aspect of the present invention, there is provided a computer readable recording medium having embodied thereon a computer program for executing a method including: generating half-tone data by applying patterns specified by each color channel to input data; rearranging the generated half-tone data according to the characteristics of the applied patterns; and predicting the rearranged half-tone data and encoding the predicted half-tone data.

According to another aspect of the present invention, there is provided a computer readable recording medium having embodied thereon a computer program for executing a method including: decoding half-tone data that is rearranged and encoded according to the characteristics of patterns applied in generating the half-tone data and predicting the decoded half-tone data; and arranging the predicted half-tone data in a reverse order with respect to the order of rearranging the generated half-tone data.

### BRIEF DESCRIPTION OF THE DRAWINGS

The above and other aspects of the present invention will become more apparent by describing in detail exemplary embodiments thereof with reference to the attached drawings in which:

FIG. 1 is a flowchart illustrating a method of encoding an image, according to an exemplary embodiment of the present invention;

FIG. 2 is a block diagram of an apparatus for encoding an image, according to an exemplary embodiment of the present invention;

FIG. 3 is a flowchart illustrating a method of decoding an image, according to an exemplary embodiment of the present invention; and

FIG. 4 is a block diagram of an apparatus for decoding an image, according to an exemplary embodiment of the present invention.

### DETAILED DESCRIPTION OF EXEMPLARY EMBODIMENTS OF THE INVENTION

Hereinafter, the present invention will be described more fully with reference to the accompanying drawings, in which exemplary embodiments of the invention are shown.

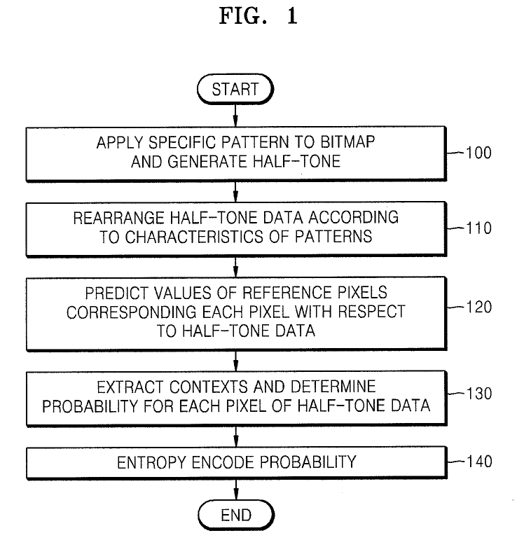

FIG. 1 is a flowchart illustrating a method of encoding an exemplary image, according to an embodiment of the present invention.

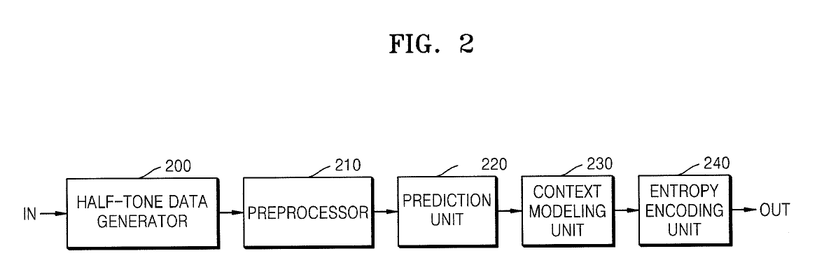

In operation 100, patterns specified by each color channel are applied to input data corresponding to a bitmap, that is, image data, and half-tone data is generated. For example, the input data may be formed of four-color channels corresponding to Cyan, Magenta, Yellow, and Black (CMYK) channels. In this case, as shown in FIG. 2, a pattern having a characteristic of a horizontal line may be applied to a cyan channel, a pattern having a characteristic of a left diagonal line may be applied to a magenta channel, a pattern having a characteristic of a right diagonal line may be applied to a yellow channel, and a pattern having a characteristic of a vertical line may be applied to a black channel.

In operation 100, each pixel value forming a bitmap, which is input data, is compared with pre-set values corresponding to each pixel of a predetermined mask and the result of the comparison is indicated by “0” or “1”, thereby generating half-tone data. For example, if the value of the pixel at the coordinates (3, 25) from among the pixels forming a bitmap, is “150” and the value of the pixel pre-set in the mask in correspondence to the coordinates (3, 25) is “250” so that the value of the pixel in the bitmap is smaller than the value of the pixel pre-set in the mask, “0” is allocated to the corresponding pixel in the half-tone data. However, according to another exemplary embodiment of the present invention, when the value of the pixel I the bitmap is larger than the value of the pixel pre=set in the mask, “1” can be allocated.

In operation 110, the half-tone data generated in operation 100 is rearranged according to the characteristics of the patterns specified by each color channel applied to input data corresponding to a bitmap in operation 100. For example, the characteristic of the patterns denotes a specific line or a period of the pixels that repeatedly appear in the half-tone data. In operation 110, the pixels of the half-tone data prepared in the pre-set location(s) of the pixels or pre-set line(s) are grouped and each group is collected into one image, thereby rearranging the half-tone data. For example, the patterns that are repeated in a form of an ‘n×n’ block can be grouped by each line of a repeated period. Here, grouping may be performed by shifting each line by the number of predetermined pixels, or the pixels prepared in the pre-set location of the pixels may be grouped in the lines without grouping by each line.

The process of rearranging the half-tone data according to the characteristics of the patterns in operation 110 is as follows.

Firstly, when the applied pattern has a characteristic of a horizontal line or a vertical line, in operation 100, the center values repeatedly exist in fixed locations in the half-tone data that is grey-scaled in a form of an ‘n×n’ block so that the pixels prepared in the locations in which the center values exist are grouped together and the remaining pixels are separately grouped, thereby rearranging the half-tone data. When the half-tone data is rearranged in this manner, the half-tone data can be rearranged to a first group and a second group, the first group being formed of lines prepared in the locations in which the center values exist and the second group being formed of the remaining pixels.

Secondly, when the pattern has a characteristic of a diagonal line, in operation 100, diagonal patterns exist in the half-tone data that is grey-scaled in a form of an ‘n×n’ block so that each line is grouped by shifting by ‘n’, thereby rearranging the half-tone data. When the half-tone data is rearranged in this manner, the half-tone data is grouped into a first group, second group, third group, and fourth group and is rearranged, thereby generating a vertical line pattern.

However, the processes are not limited thereto in operation 110 and can be variously set in consideration of the lines or locations repeated according to various characteristics of the patterns, thereby grouping the half-tone data generated in operation 100.

Since the half-tone data is rearranged according to the characteristics of the patterns in operation 110, the values of the reference pixels can be predicted more accurately in operation 120.

In operation 120, according to the pre-set manner, the values of the reference pixels corresponding to each pixel are predicted with respect to the rearranged half-tone data.

In operation 130, the contexts, which correspond to the values of the reference pixels predicted in operation 120, are extracted and the probability that each pixel value of the half-tone data is ‘0’ or ‘1’ is determined. Here, the contexts denote a vector that lists the values of the pixels prepared in the location determined by a template.

In operation 140, the probability determined in operation 130 is entropy encoded. For example, in operation 140, the probability determined in operation 130 can be arithmetic encoded or Huffman encoded.

FIG. 2 is a block diagram of an apparatus for encoding an image, according to an exemplary embodiment of the present invention. The apparatus includes a half-tone data generator 200, a preprocessor 210, a prediction unit 220, a context modeling unit 230, and an entropy encoding unit 240.

The half-tone data generator 200 applies patterns specified by each color channel to input data, input through an input terminal IN, corresponding to a bitmap, that is, image data, and generate the half-tone data. For example, the input data may be formed of four-color channels corresponding to CMYK channels. In this case, a pattern having a characteristic of a horizontal line may be applied to a cyan channel, a pattern having a characteristic of a left diagonal line may be applied to a magenta channel, a pattern having a characteristic of a right diagonal line may be applied to a yellow channel, and a pattern having a characteristic of a vertical line may be applied to a black channel.

In the half-tone data generator 200, each pixel value forming a bitmap, which is input data, is compared with pre-set values corresponding to each pixel of a predetermined mask and the result of the comparison is indicated by “0” or “1”, thereby generating half-tone data. For example, if the value of the pixel at the coordinates (3, 25), from among the pixels forming a bitmap, is “150” and the value of the pixel pre-set in the mask in correspondence to the coordinates (3, 25) is “250” so that the value of the pixel in the bitmap is smaller than the value of the pixel pre-set in the mask, “0” is allocated to the corresponding pixel in the half-tone data. However, according to another exemplary embodiment of the present invention, when the value of the pixel in the bitmap is larger than the value of the pixel pre-set in the mask, “1” can be allocated.

The preprocessor 210 rearranges the half-tone data generated in the half-tone data generator 200 according to the characteristics of the patterns specified by each color channel applied in the half-tone data generator 200. For example, the characteristic of the patterns denotes a specific line or a period of the pixels that repeatedly appear in the half-tone data. The preprocessor 210 groups the pixels of the half-tone data prepared in the pre-set location(s) of the pixel or previously set line(s) and collects each group into one image, thereby rearranging the half-tone data. For example, the patterns that are repeated in a form of an ‘n×n’ block can be grouped by each line of a repeated period. Here, grouping may be performed by shifting each line by the number of predetermined pixels, or the pixels prepared in the pre-set location of the pixels may be grouped in the lines without grouping by each line.

The process of rearranging the half-tone data according to the characteristics of the patterns applied by the preprocessor 210 is as follows.

Firstly, when the pattern that is applied by the half-tone data generator 200 has a characteristic of a horizontal line or a vertical line, the center values repeatedly exist in fixed locations in the half-tone data that is grey-scaled in a form of an ‘n×n’ block so that the pixels prepared in the locations in which the center values exist are grouped together and the remaining pixels are separately grouped, thereby rearranging the half-tone data. When the half-tone data is rearranged in this manner, the half-tone data can be rearranged to the first group and the second group, the first group being formed of lines prepared in the locations in which the center values exist and the second group being formed of the remaining pixels.

Secondly, when the pattern that is applied by the half-tone data generator 200 has a characteristic of a diagonal line, diagonal patterns exist in the half-tone data that is grey-scaled in a form of an ‘n×n’ block so that each line is grouped by shifting by ‘n’, thereby rearranging the half-tone data. When the half-tone data rearranged in this manner, the half-tone data is grouped into the first group, the second group, the third group, and the fourth group and is rearranged, thereby generating a vertical line pattern.

However, the processes are not limited thereto in the preprocessor 210 and can be variously set in consideration of the lines or locations repeated according to various characteristics of the patterns, thereby grouping the half-tone data generated in the half-tone data generator 200.

Since the half-tone data is rearranged according to the characteristics of the patterns, in the preprocessor 210, the values of the reference pixels can be predicted more accurately in operation 120.

The prediction unit 220 predicts the values of the reference pixels corresponding to each pixel with respect to the rearranged half-tone data according to the pre-set manner.

The context modeling unit 230 extracts the contexts, which correspond to the values of the reference pixels predicted in the prediction unit 220, and determines the probability that each pixel value of the half-tone data is ‘0’ or ‘1’. Here, the contexts denote a vector that lists the values of the pixels prepared in the location determined by a template.

The entropy encoding unit 240 entropy encodes the probability determined in the context modeling unit 230 and outputs the entropy-encoded probability through an output terminal OUT. For example, the entropy encoding unit 240 can arithmetic encode or Huffman encode the probability determined in the context modeling unit 230.

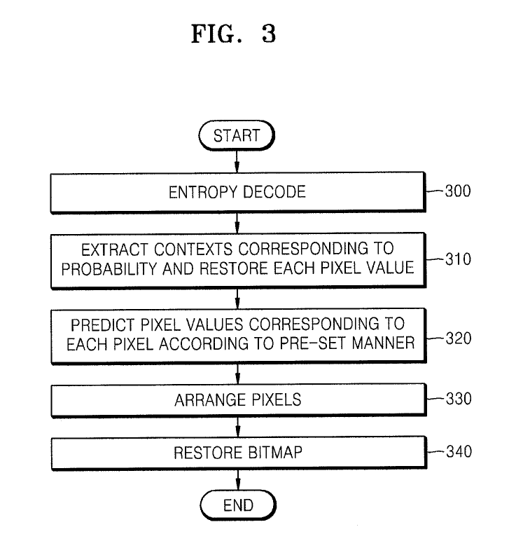

FIG. 3 is a flowchart illustrating a method of decoding an image, according to an exemplary embodiment of the present invention.

In operation 300, the half-tone data, which is rearranged in an encoding terminal according to the characteristics of the pattern and the probability predicted in a pre-set manner and entropy encoded, is entropy decoded. For example, in operation 300, the probability can be arithmetic decoded or Huffman decoded.

In operation 310, the contexts, which correspond to the entropy-decoded probability, are extracted, thereby restoring the values of each pixel.

In operation 320, the pixels corresponding to each pixel are predicted according the pre-set manner using the values of each of the pixels restored in operation 310.

In operation 330, the pixels predicted in operation 320 are arranged in an encoding terminal in a reverse order with respect to the order of rearranging the half-tone data.

In operation 340, a bitmap, which is image data, is restored using the values of the pixels arranged in operation 330.

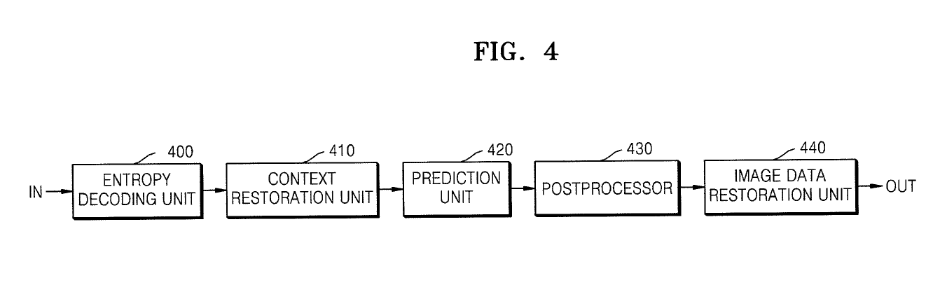

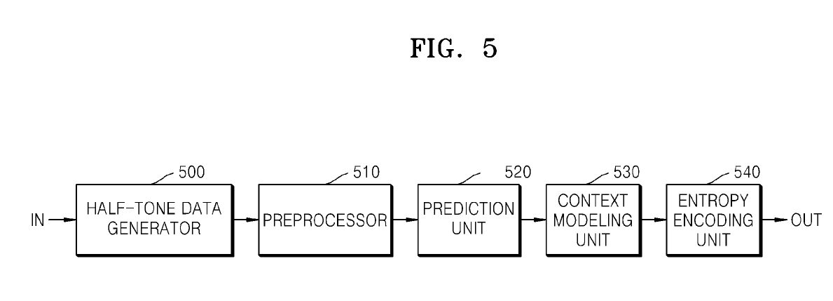

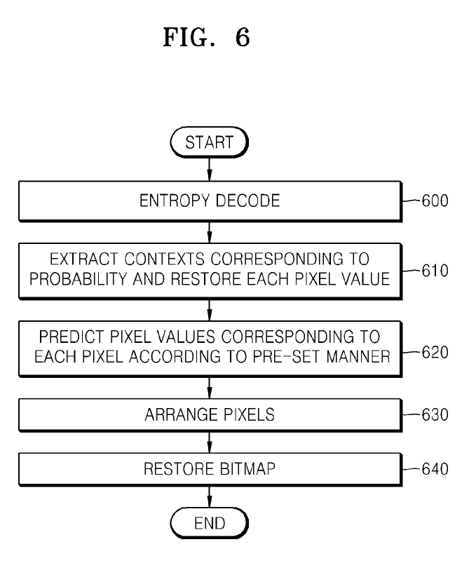

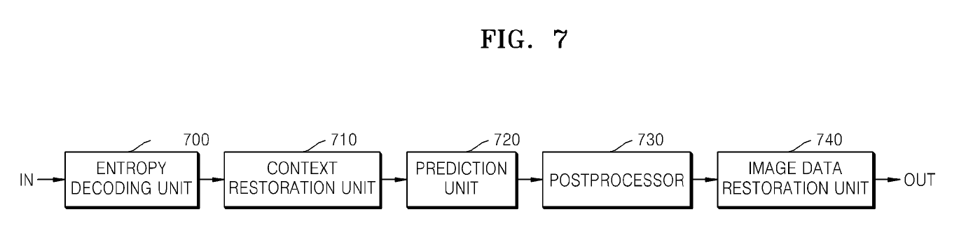

FIG. 4 is a block diagram of an apparatus for decoding an image, according to an exemplary embodiment of the present invention. The apparatus includes an entropy decoding unit 400, a context restoration unit 410, a prediction unit 420, a postprocessor 430, and an image data restoration unit 440.

The entropy decoding unit 400 rearranges the half-tone data in an encoding terminal input through an input terminal according to the characteristics of the pattern and entropy decodes the probability that is predicted in the pre-set manner and entropy encoded. For example, the entropy decoding unit 400 may arithmetic decode or Huffman decode the probability.

The context restoration unit 410 extracts the contexts, which correspond to the entropy-decoded probability, and restores the values of each pixel.

The prediction unit 420 predicts pixels corresponding to each pixel according to the pre-set manner using the values of each pixel restored in the context restoration unit 410.

The postprocessor 430 arranges the pixels predicted in the prediction unit 420 in an encoding terminal in a reverse order with respect to the order of rearranging the half-tone data.

The image data restoration unit 440 restores a bitmap, which is image data, using the pixels values arranged in the postprocessor 430 and outputs the restored bitmap through an output terminal OUT.

In the method and apparatus for encoding and decoding an image according to exemplary embodiments of the present invention, the half-tone data is rearranged, encoded, and decoded according to the characteristics of the patterns applied in generating the half-tone data, thereby performing encoding and decoding more efficiently and improving a compression rate.

The present invention can also be embodied as computer readable codes on a computer readable recording medium (including all devices having information processing functions). The computer readable recording medium may be any data storage device that can store data which can be thereafter read by a computer system. Examples of the computer readable recording medium include read-only memory (ROM), random-access memory (RAM), CD-ROMs, magnetic tapes, floppy disks, and optical data storage devices.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. A method of encoding an image, the method comprising:
generating half-tone data by applying patterns specified by each color channel to input data;
rearranging the generated half-tone data according to characteristics of the applied patterns;
predicting the rearranged half-tone data; and
encoding the predicted half-tone data.

2. The method of claim 1, wherein the characteristics of the applied patterns comprise an appearance of pixels or lines that are periodically repeated.

3. The method of claim 1, wherein the rearranging the generated half-tone data comprises grouping pixels or lines which appear as repeated characteristics in the applied patterns.

4. The method of claim 1, wherein the rearranging the generated half-tone data comprises grouping pixels in pre-set locations of the pixels or pre-set lines in the generated half-tone data.

5. An apparatus for encoding an image, the apparatus comprising:
a half-tone data generator which generates half-tone data by applying patterns specified by each color channel to input data;
a preprocessor which rearranges the generated half-tone data according to characteristics of the applied patterns; and
an entropy encoding unit which predicts the rearranged half-tone data and encodes the predicted half-tone data.

6. The apparatus of claim 5, wherein the characteristics of the applied patterns comprise an appearance of pixels or lines that are periodically repeated.

7. The apparatus of claim 5, wherein the preprocessor groups pixels or lines which appear as characteristics in the applied patterns, thereby rearranging the generated half-tone data.

8. The apparatus of claim 5, wherein the preprocessor groups pixels in pre-set locations of the pixels or pre-set lines in the generated half-tone data, thereby rearranging the generated half-tone data.

9. A method of decoding an image, the method comprising:
decoding half-tone data that is rearranged and encoded according to characteristics of patterns applied in generating the half-tone data;
predicting the decoded half-tone data; and
arranging the predicted half-tone data in a reverse order with respect to an order of rearranging the generated half-tone data when the image was encoded.

10. The method of claim 9, wherein the characteristics of the applied patterns comprise an appearance of pixels or lines that are periodically repeated.

11. The method of claim 9, wherein the half-tone data is rearranged and encoded by grouping pixels or lines which appear as repeated characteristics in the applied patterns.

12. The method of claim 9, wherein the half-tone data is rearranged and encoded by grouping pixels in pre-set locations of the pixels or pre-set lines.

13. An apparatus for decoding an image, the apparatus comprising:
a decoding unit which decodes half-tone data that is rearranged and encoded according to characteristics of patterns applied in generating the half-tone data, and predicts the decoded half-tone data; and
a postprocessor which arranges the predicted half-tone data in a reverse order with respect to an order of rearranging the generated half-tone data when the image was encoded.

14. The apparatus of claim 13, wherein the characteristics of the applied patterns comprise an appearance of pixels or lines that are periodically repeated.

15. The apparatus of claim 13, wherein the half-tone data is rearranged and encoded by grouping pixels or lines which appear as characteristics in the applied patterns.

16. The apparatus of claim 13, wherein the half-tone data is rearranged and encoded by grouping pixels in pre-set locations of the pixels or pre-set lines.

17. A computer readable recording medium having embodied thereon a computer program for executing a method comprising: generating half-tone data by applying patterns specified by each color channel to input data; rearranging the generated half-tone data according to characteristics of the applied patterns; and predicting the rearranged half-tone data and encoding the predicted half-tone data.

18. A computer readable recording medium having embodied thereon a computer program for executing a method comprising: decoding half-tone data that is rearranged and encoded according to characteristics of patterns applied in generating the half-tone data; predicting the decoded half-tone data; and arranging the predicted half-tone data in a reverse order with respect to an order of rearranging the generated half-tone data when the image was encoded.
